(19) United States
(12) Patent Application Publication
(10) Pub. No.: US 2017/0265485 A1
(43) Pub. Date: Sep. 21, 2017

(54) BREAD PRODUCT

(71) Applicant: David Patrick Froese, Keswick (CA)

(72) Inventor: David Patrick Froese, Keswick (CA)

(21) Appl. No.: 15/070,187

(22) Filed: Mar. 15, 2016

(51) Int. Cl. A21D 13/00; A21C 11/08

(52) U.S. Cl. CPC A21D 13/0025; A21C 11/08

(57) ABSTRACT

A bread product includes a first portion having a first inner surface. A second portion has a second inner surface. Any one of the first inner surface and the second inner surface defines spaced-apart pockets. The spaced-apart pockets are configured to receive, at least in part, and retain, at least in part, a condiment therein.

### TECHNICAL FIELD

This document relates to the technical field of (and is not limited to) a bread product, and a method of preparing (cooking) a bread product.

### BACKGROUND

Bread is a staple food prepared from a dough of flour and water, which is baked (cooked). Throughout recorded history, bread is popular and has been one of the oldest artificial foods since the dawn of agriculture.

Bread products may include buns (for hot dogs or hamburgers), rolls, sliced bread, loaves of bread, English muffins, and/or biscuits, etc., and any equivalent thereof.

### SUMMARY

It will be appreciated that there exists a need to mitigate (at least in part) at least one problem associated with existing bread products (also called the existing technology). After much study of the known existing bread products and the methods (of preparing bread products) with experimentation, an understanding of the problem and its solution have been identified and are articulated as follows:

Existing bread products receive a condiment (such as a mustard sauce). However, once the user attempts to eat the bread product, the condiment becomes inadvertently squeezed (forced) from the bread product and may inadvertently drip onto the user and/or on other surfaces. This arrangement leads to a mess that needs to be cleaned up.

What is needed is a bread product configured to reduce (preferably eliminate) the inadvertent release of the condiment (also called drip) from the bread product and on the user or other surfaces. This arrangement may lead to reduced (preferably eliminated) instances of messes that need to be cleaned up.

For instance, a problem associated with an assembled food product (a combination of the existing bread product with a foodstuff) is that the condiment may be displaced from its applied position. Condiments in a semi liquid form or chopped form may move from their applied positions once the assembled food item is handled and/or consumed by a person (user). This arrangement may result, for instance, in the condiment becoming displaced in a way that is unintended and potentially leading to lower satisfaction for the consumer. The condiment may move from its applied position and escape from the assembled food product. This may happen with surprising force, which results in unwanted depositing of the condiment onto a floor, a table, the consumer, and/or an innocent bystander, which requires cleaning.

Another problem is that increasing the amount and/or volume of condiments in an assembled food product may increase the risk of the displacement of one or more condiments from their applied positions relative to the existing bread product. In extreme cases, increasing the volume and/or number of condiments in an assembled food product may result in a loss in the structural integrity of the assembled food product. For instance, this may result in situations where a bread layer of a hamburger sandwich becomes separated due to the displacement of condiments.

Limiting the number and/or volume of condiments in an assembled food product may also limit the combinations of condiments that may be applied to the assembled food product. Moreover, this arrangement may limit the ability to explore different condiment combinations before encountering problems with unwanted displacement of condiments relative to the assembled food product.

To mitigate, at least in part, at least one problem associated with the existing technology, there is provided (in accordance with a first major aspect) a bread product. The bread product includes a first cooked portion having a first inner surface. The bread product also includes a second cooked portion having a second inner surface. The first cooked portion and the second cooked portion terminate at opposed end portions. The second cooked portion is configured to separate, at least in part, from the first cooked portion by a slice. The slice extends, at least in part, along a length of the second cooked portion. This is done in such a way that a foodstuff is receivable, at least in part, via the slice and between the first cooked portion and the second cooked portion. Spaced-apart bars are formed on the first inner surface. The spaced-apart bars are aligned and positioned along, at least in part, the opposed end portions. The first inner surface defines spaced-apart pockets extending, at least in part, into the first cooked portion. The spaced-apart pockets are positioned between neighboring instances of the spaced-apart bars. Generally, the spaced-apart bars separate the spaced-apart pockets (from each other). The spaced-apart pockets are aligned and positioned along, at least in part, the opposed end portions. The spaced-apart pockets are configured to receive, at least in part, and retain, at least in part, a condiment therein.

To mitigate, at least in part, at least one problem associated with the existing technology, there is provided (in accordance with a second major aspect) a bread product, including (A) a first cooked portion having a first inner surface, (B) a second cooked portion having a second inner surface, and (C) any one of the first inner surface and the second inner surface defining spaced-apart pockets. The spaced-apart pockets are configured to receive, at least in part, and retain, at least in part, a condiment therein.

To mitigate, at least in part, at least one problem associated with the existing technology, there is provided (in accordance with a third major aspect) a method for preparing a bread product. The method includes: (A) preparing an uncooked dough; and (B) forming spaced-apart bars on the uncooked dough; and (C) forming spaced-apart pockets on the uncooked dough; and (D) cooking the uncooked dough while the spaced-apart bars and the spaced-apart pockets remain formed on the uncooked dough in such a way that the uncooked dough is cooked to form the bread product. The bread product includes: (A) a first cooked portion that has a first inner surface; and (B) a second cooked portion that has a second inner surface; and (C) the first cooked portion and the second cooked portion terminate at opposed end portions; and (D) the second cooked portion is configured to separate, at least in part, from the first cooked portion by a slice; and (E) the slice extends, at least in part, along a length of the second cooked portion (this is done in such a way that a foodstuff is receivable, at least in part, via the slice and between the first cooked portion and the second cooked portion); and (F) the spaced-apart bars are formed on the first inner surface; and (G) the spaced-apart bars are aligned and positioned along, at least in part, the opposed end portions; and (H) the first inner surface defines the spaced-apart pockets extending, at least in part, into the first cooked portion; and (I) the spaced-apart pockets are positioned between neighboring instances of the spaced-apart bars; and (J) the spaced-apart pockets are aligned and positioned along, at least in part, the opposed end portions; and (K) the spaced-apart pockets are configured to receive, at least in part, and retain, at least in part, a condiment therein.

Other aspects are identified in the claims.

Other aspects and features of the non-limiting embodiments may now become apparent to those skilled in the art upon review of the following detailed description of the non-limiting embodiments with the accompanying drawings.

This Summary is provided to introduce concepts in simplified forms that are further described below in the Detailed Description. This Summary is not intended to identify key features or essential features of the disclosed or claimed subject matter, and is not intended to describe each disclosed embodiment or every implementation of the disclosed or claimed subject matter, and is not intended to be used as an aid in determining the scope of the claimed subject matter. Many other novel advantages, features, and relationships will become apparent as this description proceeds. The figures and the description more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a perspective view of an embodiment of a bread product;

FIG. 2 depicts a perspective view of an alternate embodiment of the bread product of FIG. 1;

FIG. 3 depicts a cross-sectional view taken along a cross-sectional line A-A of the bread product of FIG. 2;

FIG. 4 depicts a side view of an embodiment of the bread product of FIG. 1 assembled with a foodstuff;

FIG. 5 depicts a side view of an embodiment of the bread product of FIG. 1 assembled with a foodstuff;

FIG. 6 depicts a side view of an embodiment of the bread product of FIG. 1 assembled with a foodstuff;

FIG. 7 depicts a side view of an embodiment of a mold assembly used in the manufacture of the bread product of FIG. 1;

FIG. 8 depicts a top-down view of an embodiment of the mold assembly of FIG. 7;

FIG. 9 depicts a side view of an embodiment of the mold assembly of FIG. 7 used in the manufacture of the bread product of FIG. 1;

FIG. 10 depicts a top-down view of the mold assembly of FIG. 9;

FIG. 11 depicts a side view of an uncooked piece of uncooked dough used in the manufacture of the bread product of FIG. 1;

FIG. 12 depicts a top-down view of the uncooked piece of uncooked dough of FIG. 11 placed in a cooking pan, in which the uncooked piece of uncooked dough envelopes (at least in part) an embodiment of the mold assembly of FIG. 7;

FIG. 13 depicts a top-down view of the bread product, in which the bread product was made by cooking the uncooked piece of uncooked dough of FIG. 12 (opened to show the spaced-apart pockets, and with the mold assembly resting on or in the bread product);

FIG. 14 depicts a top-down view of the bread product of FIG. 13, made from the uncooked piece of uncooked dough of FIG. 12 (opened to reveal spaced-apart pockets and spaced-apart bars, and with the mold assembly removed from the interior of the bread product);

FIG. 15 depicts a top-down view of the bread product of FIG. 14, with a foodstuff positioned on the bread product;

FIG. 16 depicts a cross-sectional view of the bread product of FIG. 15 along a cross-sectional line B-B; and

FIG. 17 depicts a cross-sectional view of the bread product of FIG. 2.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 bread product
102 first portion
104 first inner surface
106 second portion
108 second inner surface
110 opposed end portions
112 slice
114 spaced-apart bars
116 defining spaced-apart pockets
200 uncooked dough
900 foodstuff
902 mold assembly
904 trapezoidal prisms
906 base plate
908 pyramid-shaped formations
910 cooking pan

### DETAILED DESCRIPTION OF THE EXEMPLARY EMBODIMENTS

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

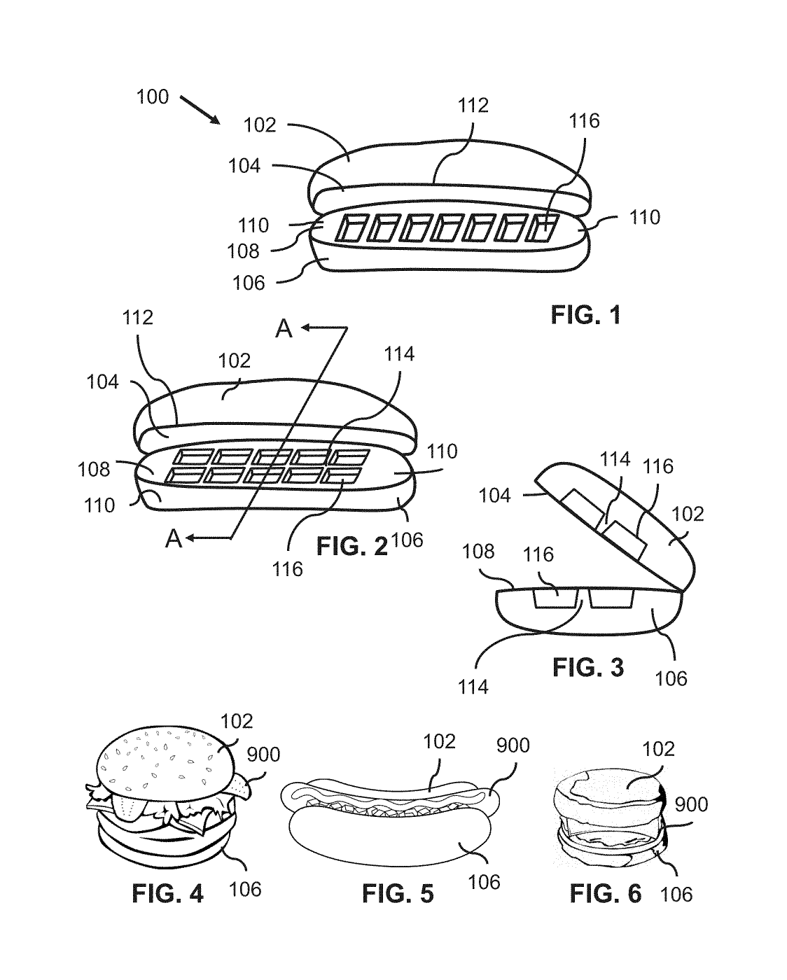

FIG. 1 depicts a perspective view of an embodiment of a bread product 100.

Referring to the embodiment as depicted in FIG. 1, a bread product 100 (also called a cooked bread product).The bread product 100 includes (and is not limited to) a synergistic combination of a first portion 102 (also called a first cooked portion) and a second portion 106 (also called a second cooked portion). The term “cooked” may include fully cooked or partially cooked, or cooked at least in part. The first portion 102 has a first inner surface 104. The second portion 106 has a second inner surface 108. The first portion 102 and the second portion 106 each terminate at opposed end portions 110.

In this embodiment, the second portion 106 is separable, at least in part, from the first portion 102 by a slice 112. The slice 112 extends, at least in part, along a length of the second portion 106. This is done in such a way that a foodstuff 900 is receivable, at least in part, via the slice 112 and between the first portion 102 and the second portion 106. The foodstuff 900 may include, for instance, a hot dog, a sausage, or any food item that may be placed into (and received by), at least in part, the bread product 100.

In this embodiment, spaced-apart bars 114 are formed on the first inner surface 104.

The spaced-apart bars 114 are aligned and positioned along, at least in part, the opposed end portions 110. The first inner surface 104 defines spaced-apart pockets 116 extending, at least in part, into the first portion 102. The spaced-apart pockets 116 are positioned between (among) neighboring instances of the spaced-apart bars 114. The spaced-apart pockets 116 are aligned and positioned along, at least in part, the opposed end portions 110.

The spaced-apart pockets 116 are configured to receive, at least in part, and retain, at least in part, a condiment. A condiment can include, and is not limited to, mustard, ketchup, relish, seasoning sauce, a wet garnish, and/or a dry garnish.

It will be appreciated that the bread product 100 includes any item that may be made into a bread or bun-like form. This can include, but is not limited to, dinner rolls, hot-dog buns, hamburger buns, gluten-free breads, biscuits, English muffins, corn bread, muffins, donuts, steamed buns, and any equivalent thereof.

Referring to the embodiment as depicted in FIG. 1, the first inner surface 104 defines a single row of spaced-apart pockets 116.

FIG. 2 depicts a perspective view of an alternate embodiment of the bread product 100 of FIG. 1.

Referring to the embodiment as depicted in FIG. 2, the first inner surface 104 defines two rows of spaced-apart pockets 116. The two rows of spaced-apart pockets 116 are positioned between (among) neighboring instances of the spaced-apart bars 114. At least one of the spaced-apart bars 114 extends, at least in part, between the opposed end portions 110.

At least some of the spaced-apart bars 114 are (approximately) perpendicular to other instances of the spaced-apart bars 114 in such a way that two rows of spaced-apart pockets 116 are defined by the spaced-apart bars 114. The two rows of spaced-apart pockets 116 are aligned and positioned along, at least in part, the opposed end portions 110. The rows of the spaced-apart pockets 116 may be staggered in alignment relative to each other and/or may be positioned in a side-by-side relationship.

In accordance with a general embodiment as depicted in FIGS. 1 and 2, the bread product 100 includes (and is not limited to): (A) a first portion 102 having a first inner surface 104, (B) a second portion 106 having a second inner surface 108, and (C) any one of the first inner surface 104 and the second inner surface 108 defining the spaced-apart pockets 116. The spaced-apart pockets 116 are configured to receive, at least in part, and retain, at least in part, a condiment therein.

Referring to a more specific embodiment as depicted in FIG. 1 and in accordance with an option, the first portion 102 and the second portion 106 terminate at opposed end portions 110, and the spaced-apart pockets 116 are arranged (aligned) to form a row of spaced-apart pockets 116 extending between opposed end portions 110.

Referring to another specific embodiment as depicted in FIG. 2, the spaced-apart pockets 116 are arranged (aligned to) form a column of spaced-apart pockets 116 extending from the front to the back of (any one of) the first portion 102 and the second portion 106.

Referring to yet another more specific embodiment as depicted in FIG. 2, the first portion 102 and the second portion 106 terminate at opposed end portions 110. The spaced-apart pockets 116 form a row of spaced-apart pockets 116 extending between opposed end portions 110. The spaced-apart pockets 116 form a column of spaced-apart pockets 116 extending from the front to the back of any one of the first portion 102 and the second portion 106.

FIG. 3 depicts a cross-sectional view taken along a cross-sectional line A-A of the bread product 100 of FIG. 2.

Referring to the embodiment as depicted in FIG. 3, any one of the first inner surface 104 and the second inner surface 108 defines two spaced-apart pockets 116. The spaced-apart pockets 116 are adjacent to the spaced-apart bar 114. The spaced-apart pockets 116 extend into any one of the first portion 102 and/or the second portion 106 (or both). A condiment is to be received and stored in the spaced-apart pockets 116. A condiment may include, and is not limited to, mustard, ketchup, relish, seasoning sauce, a wet garnish, or a dry garnish, etc., and any equivalent thereof.

FIG. 4 depicts a side view of an embodiment of the bread product 100 of FIG. 1 assembled with a foodstuff 900.

Referring to the embodiment as depicted in FIG. 4, the bread product 100 (in use) receives the food item 900. The first portion 102 may be separated completely from the second portion 106 (if so desired). The first portion 102 includes (is utilized as) the top bun or bread layer, and the second portion 106 includes (is utilized as) the bottom bun or bread layer. The foodstuff 900 is placed between the first portion 102 and the second portion 106, thereby forming an assembled food sandwich. The foodstuff 900 includes, for instance, a patty-like food; it will be appreciated that any type of foodstuff 900 may be placed between a top bun and a bottom bun (or bread layer) of the bread product 100. Examples of the foodstuff 900 may include, and are not limited to, lunch meats, thick slices of meat or meat products, vegetables, cheese, food pastes such as peanut butter, eggs, etc., and any equivalent thereof.

FIG. 5 depicts a side view of an embodiment of the bread product 100 of FIG. 1 assembled with a foodstuff 900.

Referring to the embodiment as depicted in FIG. 5, the bread product 100 receives a hot dog. The first portion 102 is partially separated from the second portion 106 so that the bread product 100 wraps, at least in part, around the foodstuff 900 (shown as a hot dog). It will be appreciated that the foodstuff 900 may include any type of tubular or elongated food or food product, such as, and not limited to, sausages, cheese sticks, vegetables, food pastes such as peanut butter, and meatballs, and any equivalent thereof.

FIG. 6 depicts a side view of an embodiment of the bread product 100 of FIG. 1 assembled with a foodstuff

Referring to the embodiment as depicted in FIG. 6, the first portion 102 is fully separated from the second portion 106. The first portion 102 is used as the bottom bun, and the second portion 106 is used as the top bun, or vice versa. The foodstuff 900 is placed between the first portion 102 and the second portion 106, thereby forming the assembled breakfast sandwich. The bread product 100 may include, and is not limited to, an English muffin, biscuit, wheat-based bun, or gluten-free bun, etc., and any equivalent thereof. Furthermore, any foodstuff 900 may be placed between a top bun and a bottom bun.

FIG. 7 depicts a side view of an embodiment of a mold assembly 902 used in the manufacture (cooking or baking) of the bread product of FIG. 1.

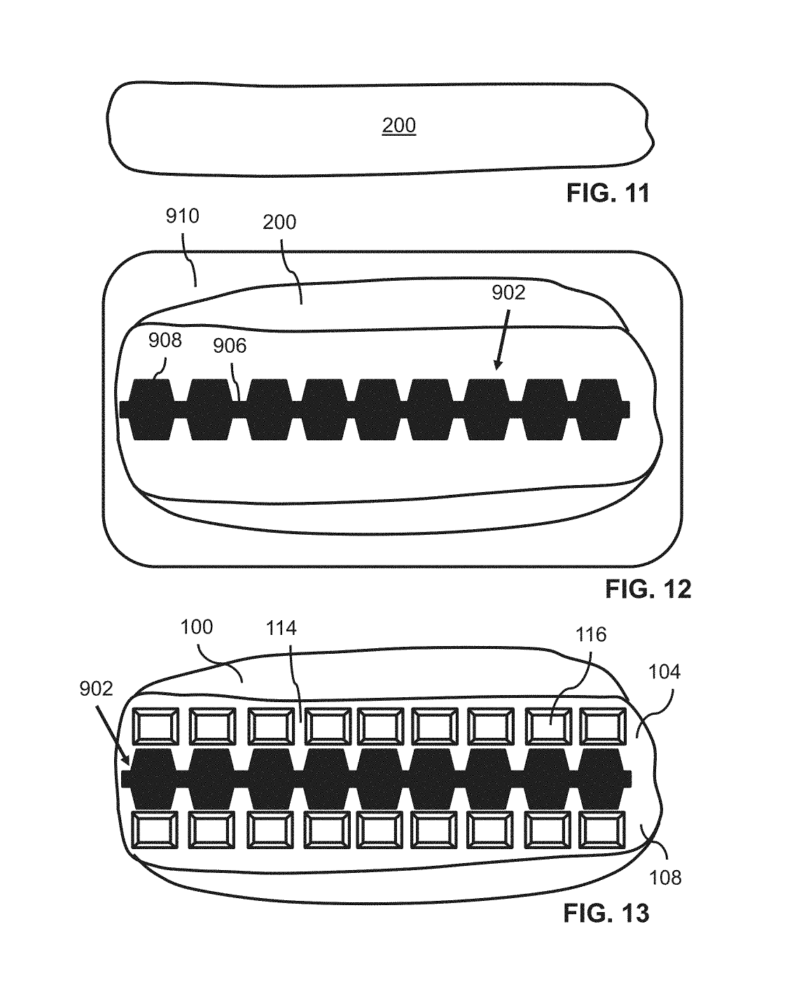

Referring to the embodiment as depicted in FIG. 7, the mold assembly 902 is configured to be enveloped, at least in part, by an uncooked dough 200 (as depicted in FIGS. 11 to 13) prior to the cooking (preparation) of the uncooked dough 200 (by application of a cooking process, such as usage of an oven, etc.). Once the uncooked dough 200 has been sufficiently cooked, the uncooked dough 200 forms the bread product 100. Once formed, the bread product 100 is sliced, at least in part, and the mold assembly 902 is exposed and removed from the bread product 100. Since the bread product 100 is relatively less elastic than the uncooked dough 200, the impressions formed by the mold assembly 902 on the bread product 100 are retained on or by any one of the first inner surface 104 and the second inner surface 108 of the bread product 100. Referring to the embodiment as depicted in FIG. 7, the mold assembly 902 is configured to (A) form at least two or more rows (or at least one row) of spaced-apart pockets 116 on at least one of the first inner surface 104 and the second inner surface 108 of the bread product 100, and/or (B) form the spaced-apart bars 114 on at least one of the first inner surface 104 and the second inner surface 108 of the bread product 100.

Preferably, the mold assembly 902 has (provides or defines) a row of trapezoidal prisms 904 extending approximately perpendicularly from opposed faces of a base plate 906. This is done in such a way that the rows of trapezoidal prisms 904 are defined or formed (such as, one row of trapezoidal prisms 904 for each face of the base plate 906).

The trapezoidal prisms 904 are confirmed to form or define the spaced-apart pockets 116 of the bread product 100 (during the cooking process). At least some portions of the face of the base plate 906 are configured to form or define the spaced-apart bars 114 of the bread product 100. The trapezoidal prisms 904 extend from the top face of the base plate 906. Preferably, the trapezoidal prisms 904 extend approximately perpendicularly from the top face of the base plate 906. The trapezoidal prisms 904 are configured to form (during the cooking process) at least some of the spaced-apart pockets 116 and/or at least some of the spaced-apart bars 114 of the first inner surface 104 of the bread product 100, etc. Similarly, the trapezoidal prisms 904 extending approximately perpendicularly from the bottom face of the base plate 906 are configured to form or define (during the cooking process) at least some of the spaced-apart pockets 116 and/or at least some of the spaced-apart bars 114 of the second inner surface 108 of the bread product 100.

It will be appreciated that the mold assembly 902 may include any suitable material (such as a metal alloy, a metal coated with an anti-sticking surface, a silicone material, etc., and any equivalent thereof) that is configured to withstand cooking temperatures associated with the cooking process for cooking the uncooked dough 200 without degrading, melting, deforming, or otherwise negatively impacting the quality of the bread product 100. Materials that may be used in the manufacture of the mold assembly 902 may include, and are not limited to, stainless steel, food-grade silicon, food-grade plastics, ceramic, and glass, etc., and any equivalent thereof.

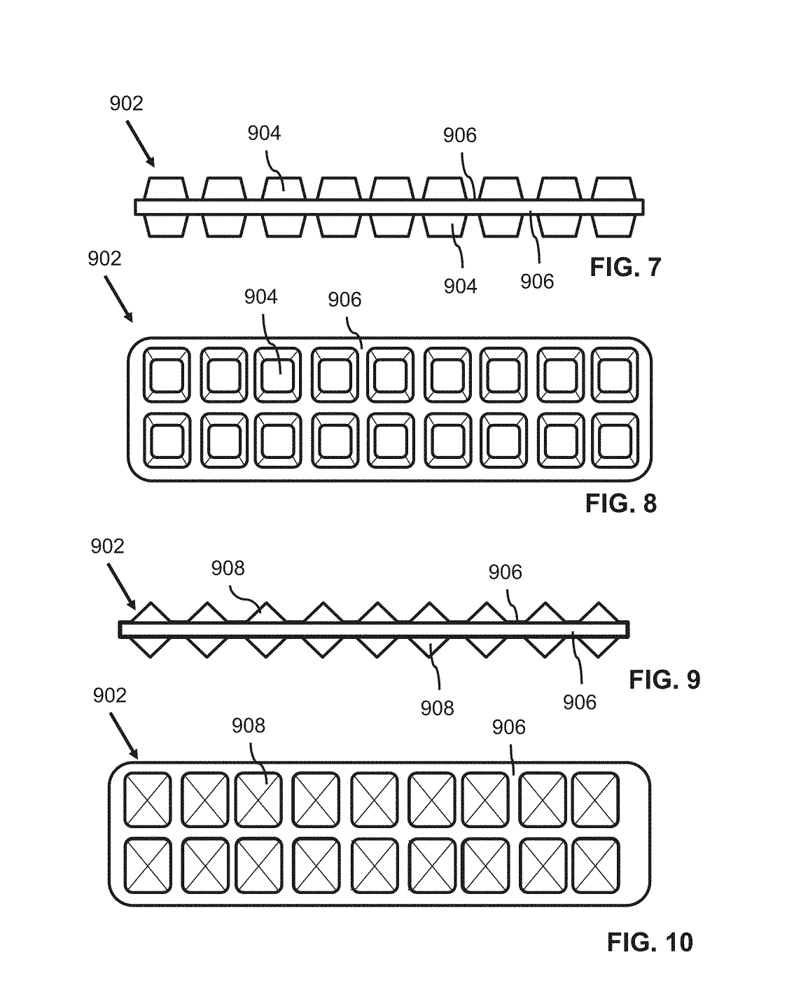

FIG. 8 depicts a top-down view of an embodiment of the mold assembly 902 of FIG. 7.

Referring to the embodiment as depicted in FIG. 8, the mold assembly 902 has two rows of trapezoidal prisms 904 extending approximately perpendicularly from the top face of the base plate 906. The two rows of trapezoidal prisms 904 are configured to form (define) (during the cooking process) the spaced-apart pockets 116 and/or the spaced-apart bars 114 of the first inner surface 104 of the bread product 100.

In accordance with an option, the mold assembly 902 includes two rows of trapezoidal prisms 904 extending from the bottom face of the base plate 906, in which the two rows of trapezoidal prisms 904 are configured to form (during the cooking process) at least some of the spaced-apart pockets 116 and/or at least some of the spaced-apart bars 114 of the second inner surface 108 of the bread product 100.

FIG. 9 depicts a side view of an embodiment of the mold assembly 902 of FIG. 7 used in the manufacture of the bread product 100 of FIG. 1.

Referring to the embodiment as depicted in FIG. 9, the mold assembly 902 has a row of pyramid-shaped formations 908 extending approximately perpendicularly from each face of a base plate 906 (this is done in such a way that two rows of pyramid-shaped formations 908 in total are formed (one row of pyramid-shaped formations 908 for each face of the base plate 906).

FIG. 10 depicts a top-down view of the mold assembly 902 of FIG. 9.

Referring to the embodiment as depicted in FIG. 10, the mold assembly 902 provides at least two rows of pyramid-shaped formations 908 extending approximately perpendicularly from the top face of the base plate 906, in which at least two rows of pyramid-shaped formations 908 are configured to form (during the cooking process) at least some of the spaced-apart pockets 116 and/or at least some of the spaced-apart bars 114 of the first inner surface 104 of the bread product 100.

In accordance with an option, the mold assembly 902 provides at least two rows of pyramid-shaped formations 908 extending from the bottom face of the base plate 906, in which at least two rows of pyramid-shaped formations 908 are configured to form (during the cooking process), at least some of spaced-apart pockets 116 and/or at least some of the spaced-apart bars 114 of the second inner surface 108 of the bread product 100.

It will be appreciated that any suitable shape of the pyramid-shaped formations 908 may extend from the base plate 906 in such a way that at least some of the spaced-apart pockets 116 are formed in the bread product 100 (during the cooking process). Embodiments of the types of shapes that may be used to form the pyramid-shaped formations 908 include, and are not limited to, half-spheres, three-dimensional likenesses of characters, cylinders, and any shape that may form corresponding spaced-apart pockets 116 in the bread product 100 (provided the shape is suitable for receiving a condiment, at least in part.

Referring to the embodiments as depicted in FIG. 8 and FIG. 10, a two-row pattern is depicted. It will be appreciated that other embodiments of patterns may be used, and may include, and are not limited to, a single row pattern, a zig-zag pattern, a grouped pattern, or any pattern that may be configured to receive a condiment (at least in part).

It will also be appreciated that more than one instance of the mold assembly 902 may be enveloped, at least in part, by the uncooked dough 200. For example, two or more mold assemblies 902, each having shapes extending from only one face of each of the respective base plates of the mold assemblies, may be enveloped (at least in part) by the uncooked dough 200 (this is done in such a way that the shapes may form, during the cooking process, any one of (A) at least some of the spaced-apart pockets 116 on the first inner surface 104, (B) at least some of the second inner surface 108. Other combinations of two or more mold assemblies, each having their own pattern of shapes corresponding to spaced-apart pockets 116 may be used (if so desired).

FIG. 11 depicts a side view of an uncooked piece of uncooked dough 200 used in the manufacture of the bread product 100 of FIG. 1.

Referring to the embodiment as depicted in FIG. 11, the uncooked dough 200 is, through the process of cooking (such as baking, steaming, deep-frying, etc.), formed (at least in part) into the bread product 100. It will be appreciated that a dough of any type or food ingredient may be used (food ingredient compatible for human consumption). The food ingredient may include, and is not limited to, a leavened dough, an unleavened dough, a gluten-free dough, a multi-grain dough, an egg-based dough, a brioche dough, or any other type of dough that may be used to form a bread product 100.

FIG. 12 depicts a top-down view of the uncooked piece of uncooked dough 200 of FIG. 11 placed in a cooking pan 910, in which the uncooked piece of uncooked dough 200 envelopes (at least in part, an embodiment of the mold assembly 902 of FIG. 7.

Regarding the embodiment as depicted in FIG. 12, the mold assembly 902 is inserted (at least in part) into the uncooked dough 200. The uncooked dough 200 may be enveloped, at least in part, around the mold assembly 902. By way of example, the uncooked dough 200 may be split open, and the mold assembly 902 may be inserted (at least in part) into the interior of the uncooked dough 200. For example, it may be advantageous to position the mold assembly 902 in the uncooked dough 200 prior to, during, or after a leavening process (for a leavened bread). It will be appreciated that the mold assembly 902 may be positioned in the uncooked dough 200 at any time before the uncooked dough 200 is cooked (by a cooking process, such as baking, in order to cook the uncooked dough 200 with the mold assembly 902 inserted, at least in part, therein).

It will also be appreciated that the mold assembly 902 may be positioned in any suitable orientation in the uncooked dough 200. For example, in some situations, it may be advantageous to position the mold assembly 902 such that the base plate 906 of the mold assembly 902 is approximately parallel to the base of the cooking pan 910.

The combination of the mold assembly 902 and the uncooked dough 200 is inserted (at least in part) into the cooking pan 910. This is done in such a way that the base plate 906 of the mold assembly 902 is relatively perpendicular to the base of the cooking pan 910.

It will also be appreciated that the uncooked dough 200 may partially envelop the mold assembly 902. For example, in some situations, it may be advantageous to position the mold assembly 902 on top of the uncooked dough 200 so that the uncooked dough 200 envelopes one face of the mold assembly 902. Other ways of enveloping the mold assembly 902 using the uncooked dough 200 may include partially enveloping both faces of half of a mold assembly 902, etc.

FIG. 13 depicts a top-down view of the bread product 100, in which the bread product 100 was made by cooking the uncooked piece of uncooked dough 200 of FIG. 12 (opened to show the spaced-apart pockets 116, and with the mold assembly 902 resting on or in the bread product 100).

Regarding the embodiment as depicted in FIG. 13, the uncooked dough 200 of FIG. 12 has been cooked (preferably fully cooked or flash cooked or partially cooked). The mold assembly 902 is separated, at least in part, from the bread product 100 to show at least some of the spaced-apart pockets 116 and/or the spaced-apart bars 114 on any one of the first inner surface 104 and the second inner surface 108 of the bread product 100. Once the mold assembly 902 has been separated from the bread product 100, the mold assembly 902 may be completely removed from the bread product 100.

It will be appreciated that the mold assembly 902, by being partially enveloped by the uncooked dough 200, may assist, at least in part, in the forming of a slice (not shown) once the uncooked dough 200 is formed into the bread product 100 through cooking. For this case, the mold assembly 902 may be removable without the need for extensive cutting or slicing.

It will also be appreciated that in scenarios where, for example, the uncooked dough 200 completely (or almost completely) envelopes the mold assembly 902, it may be necessary to slice the bread product 100 using a knife or slicer (not shown). This may be necessary in order to remove the mold assembly 902 from the bread product 100 once the uncooked dough 200 has been cooked.

In accordance with the embodiments as depicted in FIGS. 11 to 13, there is provided a method for preparing the bread product 100. The method includes operation (A). Operation (A) includes preparing an uncooked dough 200 (using known methods that are not described here in detail). The method also includes operation (B). Operation (B) includes forming the spaced-apart bars 114 on the uncooked dough 200 (by utilizing the mold assembly 902). The method also includes operation (C). Operation (C) includes forming the spaced-apart pockets 116 on the uncooked dough 200 (by using the mold assembly 902). The method also includes operation (D). Operation (D) includes cooking the uncooked dough 200 (such as, in an oven, etc.) while the spaced-apart bars 114 and the spaced-apart pockets 116 remain formed on the uncooked dough 200 in such a way that the uncooked dough 200 is cooked to form the bread product 100. The operation of cooking may include any type of suitable or compatible cooking process appropriate for cooking the uncooked dough 200.

In accordance with the embodiments as depicted in FIGS. 11 to 13 and FIGS. 1 and 2, there is provided a method for preparing the bread product 100. The method includes (and is not limited to) (A) preparing the uncooked dough 200, (B) forming the spaced-apart pockets 116 on the uncooked dough 200, and (C) cooking the uncooked dough 200 while the spaced-apart pockets 116 remain formed on the uncooked dough 200 in such a way that the uncooked dough 200 is cooked to form the bread product 100.

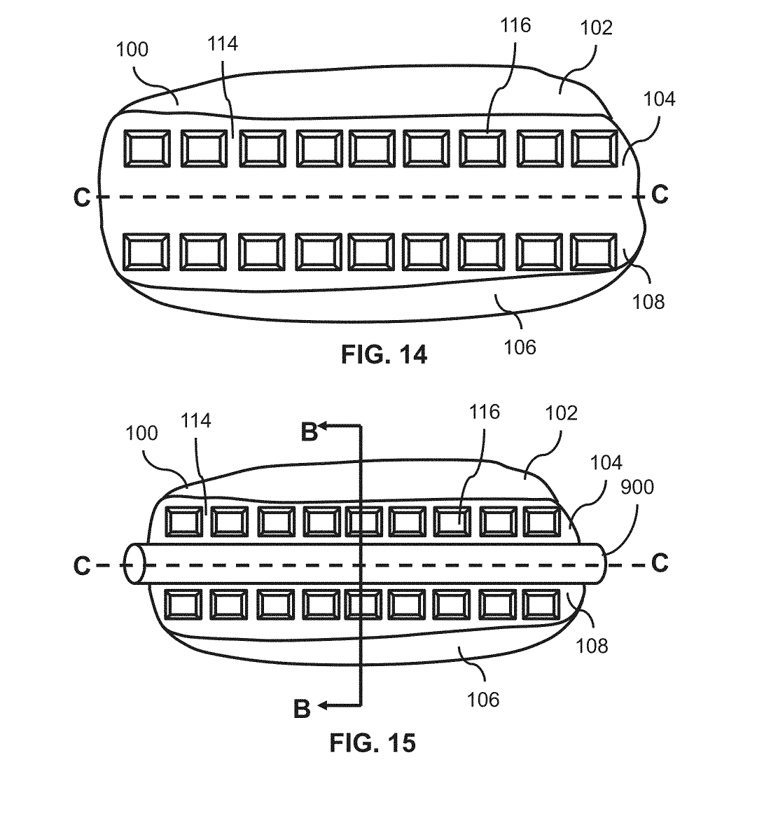

FIG. 14 depicts a top-down view of the bread product 100 of FIG. 13, made from the uncooked piece of uncooked dough 200 of FIG. 12 (opened to reveal spaced-apart pockets 116 and/or spaced-apart bars 114, and with the mold assembly 902 separated (removed from) the interior of the bread product 100).

Regarding the embodiment as depicted in FIG. 14, the bread product 100 has been sliced, at least in part, and the mold assembly 902 (as depicted in FIG. 13) has been separated from the bread product 100. The bread product 100 is partially sliced so as to retain a single instance of the bread product 100. The bread product 100 may be foldable, at least in part, along the fold axis C-C so that the portion of the bread product 100 above the fold axis C-C forms the first portion 102 of the bread product 100, and the portion of the bread product 100 below the fold axis C-C forms the second portion 106 of the bread product 100.

In accordance with an embodiment, the bread product 100 is cut before the mold assembly 902 has been removed from the bread product 100. For instance, the bread product 100 may be cut along the fold axis C-C so as to produce two portions of a bread product 100. It will be appreciated that the bread product 100 may be cut or folded along any single axis or combination of axes.

In some cases, it may be advantageous to fold the bread product 100 along several fold lines in order to wrap or surround a foodstuff 900.

FIG. 15 depicts a top-down view of the bread product 100 of FIG. 14, with a foodstuff 900 positioned on the bread product 100.

Regarding the embodiment as depicted in FIG. 15, the foodstuff 900 is placed on the bread product 100 of FIG. 14 along the fold axis C-C. The first portion 102 of the bread product 100 and the second portion 106 of the bread product 100 may be folded, at least in part, along the axis C-C so as to surround, at least in part, the foodstuff 900.

Condiments may be placed in any one of the spaced-apart pockets 116 of the first portion 102 and the second portion 106 of the bread product 100. The condiments may be utilized to fill, at least in part, the spaced-apart pockets 116, etc. The condiments may include, and are not limited to, sauces, relishes, mayonnaise, ketchup, and small pieces of food items such as bacon bits and/or diced onions, and any equivalent thereof.

It will be appreciated that larger types of condiments may be too large for insertion into the spaced-apart pockets 116, but may, instead, contact, at least in part, the spaced-apart bars 114 on any one of the first portion 102 and the second portion 106 of the bread product 100. The relatively larger condiments may include, and are not limited to, pickle slices, tomato slices, pickle spears, peppers, and sliced onions, and any equivalent thereof.

It will also be appreciated that, in some applications, larger condiments of the foodstuff 900 may help prevent, at least in part, the condiments that are received in the spaced-apart pockets 116 from escaping from the spaced-apart pockets 116. For example, a cheese slice may be used to cover, at least in part, at least some of the spaced-apart pockets 116 of the bread product 100. This arrangement may reduce (at least in part) the risk of the condiment inadvertently escaping from the spaced-apart pockets 116. In another example, referring to FIG. 15, once the bread product 100 is folded along the fold axis C-C, the foodstuff 900 may cover, at least in part, some of the spaced-apart pockets 116 of the bread product 100.

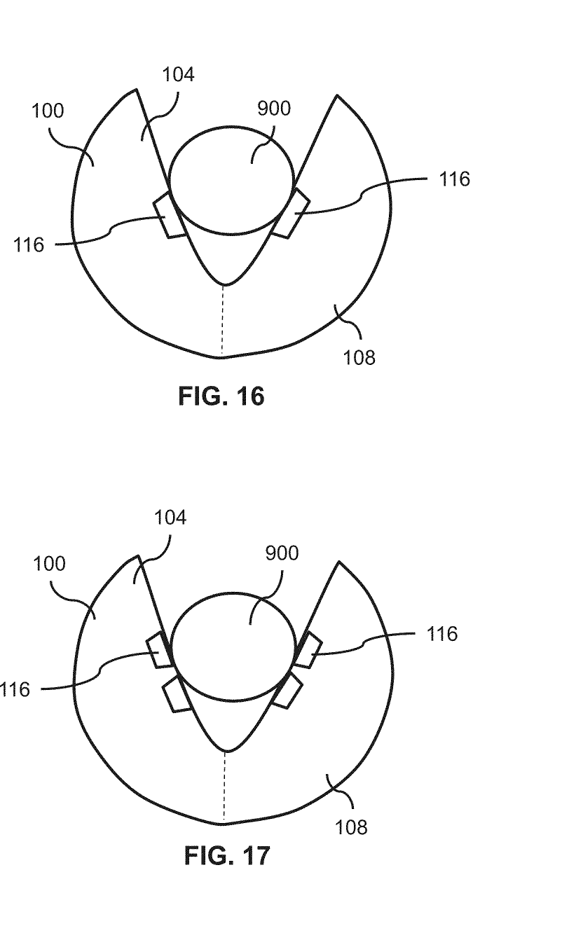

FIG. 16 depicts a cross-sectional view of the bread product 100 of FIG. 15 along a cross-sectional line B-B.

Regarding the embodiment as depicted in FIG. 16, the foodstuff 900 is placed on the bread product 100 so as to cover, at least in part, the spaced-apart pockets 116 in any one of the first inner surface 104 and the second inner surface 108 of the bread product 100. In this embodiment, the foodstuff 900 is placed on the bread product so as to contact, at least in part, the spaced-apart bars 114 of any one of the first inner surface 104 and the second inner surface 108 of the bread product 100.

Condiments and/or larger types of condiments may also be placed in the space defined between the foodstuff 900 and the bread product 100. Furthermore, condiments and/or larger types of condiments may also be placed in the space above the foodstuff 900.

It will be appreciated that the space above the foodstuff 900 and the space between the foodstuff 900 and the bread product 100 may depend on the characteristics of the foodstuff being placed on the bread product 100. For example, the foodstuff 900 may include, and is not limited to, meat patties, meat slices, and schnitzel-type foodstuffs. The bread product 100 may limit the space available for condiments and/or larger types of condiments both above the foodstuff 900 and in the space between the foodstuff 900 and the bread product 100.

It will also be appreciated that condiments and/or larger types of condiments may be placed between (among) the foodstuff 900 and the first inner surface 104 and/or the second inner surface 108 of the bread product 100. For example, larger types of condiments such as, and not limited to, cheese slices, tomato slices, and sliced onions, may be placed between (among) the foodstuff 900 and the first inner surface 104 and/or the second inner surface 108 of the bread product 100.

FIG. 17 depicts a cross-sectional view of an embodiment of the bread product 100 of FIG. 2.

Referring to the embodiment as depicted in FIG. 17, the bread product 100 is folded, at least in part, in such a way that the bread product 100 surrounds (envelopes), at least in part, the foodstuff 900. The foodstuff 900 is placed on the bread product 100 so as to cover, at least in part, the two rows of spaced-apart pockets 116 formed in the first inner surface 104 and/or the second inner surface 108 of the bread product 100. The foodstuff 900 is placed on the bread product 100 so as to also contact, at least in part, the spaced-apart bars 114 of the first inner surface 104 and/or the second inner surface 108 of the bread product 100. The increased number of spaced-apart pockets 116 formed in any one (or each) of the first inner surface 104 and/or the second inner surface 108 of the bread product 100 may allow for a greater volume or combination of condiments to be placed in (received by) the bread product 100.

It will be appreciated that the description identifies and describes options and variations of the bread product 100, regardless of whether the description identifies the options and/or variations of the bread product 100 by way of explicit terms and/or non-explicit terms. Other options for the bread product 100 as identified in this paragraph may include any combination and/or permutation of the technical features (assemblies, components, items, devices, etc.) as identified in the detailed description, as may be required and/or desired to suit a particular technical purpose and/or technical function. It will be appreciated, that where possible, any one or more of the technical features and/or any one or more sections of the technical features of the bread product 100 may be combined with any other one or more of the technical features and/or any other one or more sections of the technical features of the bread product 100 in any combination and/or permutation. Any one or more of the technical features and/or any one or more sections of the technical features of the bread product 100 may stand on its own merit without having to be combined with another technical feature. It will be appreciated that persons skilled in the art would know that technical features of each embodiment may be deployed (where possible) in other embodiments even if not expressly stated as such above. It will be appreciated that persons skilled in the art would know that other options would be possible for the configuration of the components of the bread product 100 (if so desired) to adjust to manufacturing requirements and still remain within the scope of the invention as described in at least one or more of the claims. This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims. It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. A bread product, comprising:
a first portion having a first inner surface; and
a second portion having a second inner surface; and
any one of the first inner surface and the second inner surface defining spaced-apart pockets; and
the spaced-apart pockets being configured to receive, at least in part, and retain, at least in part, a condiment therein.

2. The bread product of claim 1, wherein:
the first portion and the second portion terminate at opposed end portions; and
the spaced-apart pockets are formed into a row of spaced-apart pockets extending between the opposed end portions.

3. The bread product of claim 1, wherein:
the spaced-apart pockets form a column of spaced-apart pockets extending from a front to a back of the first portion and the second portion.

4. The bread product of claim 1, wherein:
the first portion and the second portion terminate at opposed end portions; and
the spaced-apart pockets form a row of spaced-apart pockets extending between the opposed end portions; and
the spaced-apart pockets form a column of spaced-apart pockets extending from a front to a back of the first portion and the second portion.

5. A bread product, comprising:
a first portion having a first inner surface; and
a second portion having a second inner surface; and
the first portion and the second portion terminating at opposed end portions; and
the second portion being configured to separate, at least in part, from the first portion by a slice; and
the slice extending, at least in part, along a length of the second portion in such a way that a foodstuff is receivable, at least in part, via the slice and between the first portion and the second portion; and
spaced-apart bars being formed on the first inner surface; and
the spaced-apart bars being aligned and positioned along, at least in part, the the opposed end portions; and
the first inner surface defining spaced-apart pockets extending, at least in part, into the first portion; and
the spaced-apart pockets being positioned among neighboring instances of the spaced-apart bars; and
the spaced-apart pockets being aligned and positioned along, at least in part, the opposed end portions; and
the spaced-apart pockets being configured to receive, at least in part, and retain, at least in part, a condiment therein.

6. The bread product of claim 5, wherein:
the spaced-apart pockets are sized to prevent receiving, at least in part, the foodstuff therein.

7. The bread product of claim 5, wherein:
the first portion and the second portion terminate at the opposed end portions; and
the spaced-apart pockets form a row of spaced-apart pockets extending between the opposed end portions.

8. The bread product of claim 5, wherein:
the spaced-apart pockets form a column of spaced-apart pockets extending from a front to a back of the first portion and the second portion.

9. The bread product of claim 5, wherein:
the first portion and the second portion terminate at the opposed end portions; and
the spaced-apart pockets are arranged to form: (A) a row of spaced-apart pockets extending between the opposed end portions, and (B) a column of spaced-apart pockets extending from a front to a back of the first portion and the second portion.

10. The bread product of claim 5, wherein:
the rows of the spaced-apart pockets are staggered in alignment relative to each other.

11. The bread product of claim 5, wherein:
the rows of the spaced-apart pockets are positioned in a side-by-side relationship.

12. The bread product of claim 5, wherein:
a mold assembly is configured to form the spaced-apart pockets.

13. The bread product of claim 5, wherein:
a mold assembly is configured to form the spaced-apart pockets and the spaced-apart bars, and the spaced-apart bars separate the spaced-apart pockets.

14. The bread product of claim 13, wherein:
the mold assembly defines a trapezoidal prism.

15. The bread product of claim 13, wherein:
the mold assembly defines a pyramid-shaped formation.

16. A method for preparing a bread product, comprising:
preparing an uncooked dough; and
forming spaced-apart pockets on the uncooked dough; and
cooking the uncooked dough while the spaced-apart pockets remain formed on the uncooked dough in such a way that the uncooked dough is cooked to form the bread product comprising a first portion having a first inner surface, and a second portion having a second inner surface, and any one of the first inner surface and the second inner surface defining spaced-apart pockets, and the spaced-apart pockets being configured to receive, at least in part, and retain, at least in part, a condiment therein.
